(19) United States
(12) Patent Application Publication
(10) Pub. No.: US 2012/0023479 A1
(43) Pub. Date: Jan. 26, 2012

(54) METHOD AND A COMPUTER PROGRAM PRODUCT FOR AUTOMATICALLY GENERATING A USER INTERFACE FOR AN APPLICATION PROGRAM

(76) Inventor: Gregory S. Moress, Gainesville, FL (US)

(21) Appl. No.: 12/840,895

(22) Filed: Jul. 21, 2010

(51) Int. Cl. G06F 9/45; G06F 9/44

(52) U.S. Cl. 717/108; 717/106; 717/140; 717/162; 717/149

(57) ABSTRACT

A method and a computer program product include the steps of receiving, into a computing machine, a business logic (BL) source code for an application program, the BL source code comprising at least a class, an object and a method or function. Steps transform, in the computing machine, the BL source code into an executable BL. Steps acquire schema information from the BL source code. Steps generate, in the computing machine, a user interface (UI) source code for a form using the schema information for the class. Steps transform, in the computing machine, the UI source code into at least one executable UI.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to software applications. More particularly, the invention relates to a method and means for the automatic generation of the presentation layer for a software application.

### BACKGROUND OF THE INVENTION

Since hardware platforms and operating systems (OS) are prolific, computer language designers have tried their best to design languages that run on as many platforms and operating systems as possible. The grandfather languages C and C++ can create Business Logic (BL) that runs virtually everywhere; however, the portability breaks when making OS-specific calls and writing User-Interfaces (UI). The languages Java and C# have been designed to overcome these limitations, yet when designing an application, the developer must still choose between targeting either the OS, a browser, a run-time environment (RTE) such as Java or Flash, or expose the code's functionality as Web Services. Furthermore, the creation of the UI must be written by a developer. The term UI is usually used when referring to standalone applications, while the term presentation layer (PL) is most often used when referring to n-tier or client-server applications. Both terms will be used interchangeably herein. Runtime Environment will now mean the environment in which an application executes. This may be the OS, as is the case for native applications, a browser as is the case for Web applications, the Java Virtual Machine (JVM), Microsoft's Common Language Runtime (CLR), Adobe Flash, etc.

Applications which exist solely within the address space of a single machine are said to be standalone applications, while applications that are distributed across more than one machine are said to be distributed, n-tier, or client/server. When an application is standalone, the BL and UI layers can be tightly-coupled, whereas distributed applications have loosely-coupled BL and PL connectivity, which means the BL and PL communicate across a network using available protocols.

Often when re-writing an application for another RTE, the original application must be maintained. This duplication results in maintaining two codebases, which increases expenditure and doubles the chances for errors. Furthermore, porting a program from one language to another, common when targeting a new RTE, is a time-consuming and error prone task. It is therefore an objective of the present invention to provide a solution that enables BL written in any supported language targeting any supported RTE to be interacted with from any supported RTE.

The way in which Java and C# achieve platform independence is by requiring a RTE to exist for each platform intended to execute programs for that language. Also, at least one Design Time Environment (DTE) must exist for a platform, allowing the development of programs targeting the available RTEs.

The term ‘Visual Programming’ refers to the ability to construct UI forms in a development environment (at design time) using visual icons presented by the UI of the DTE. A programmer can add a button to a form by dragging an icon from a toolbox and dropping it onto a form. The DTE automatically adds the code to create the button, as well as render it on the screen. As nice an advance as this is from populating a form with controls using only code, the button in this case does not have a name, nor do anything when clicked.

When software executes having full access to the machine it runs upon it is considered to be a native application. The drawback to this approach is that it makes the program tied to a specific platform, or Platform Dependent (PD). Developers strove to make application Platform Independent (PI) by creating RTE(s) for a variety of platforms, and writing software that targets the RTE. Java being the leading example. So RTE(s) make PI easily attainable, even allowing code to be run in or outside of a browser, as long as the RTE can be run inside or outside of a browser. But there is difficulty in getting code targeting one RTE to interact with code, or a user, in a different RTE, hence the need for a RTE Independent (RTEI) solution.

Since the beginning of software development, debuggers have displayed the internal status of the program that is being debugged using a UI of its own design and construction. Typically, a debugger illustrates a program's variables using a two column grid, with column one being the variable's name and column two being the value of that variable. This ‘debug-view’ is provided by the debugger using schema information about the program being debugged, and the runtime data of the application.

Other software developers have made improvements on this ‘debug-view’ concept, and have used software components that assist in creating user interfaces for specific subsets of purposes. However, none yet provide functionality that eliminates the need for software developers to be involved in interfacing the BL with the UI. Also, none are object oriented (OO), since although they render forms to be populated with data, the programmer must decide where the data goes and what to do next.

One currently known software solution provides automatic selection of UI controls. This solution is explicitly designed for runtime execution; however, it is not designed to work at design-time. It is specific to UI controls that allow choosing a selection among elements. Therefore, it decides whether to put a listbox on a form or a set of check boxes based on the number of choices in a set. This solution does not create controls from schema information, but determines which control to create based on the number of elements in a selection set. Also, this solution does not know what to do with the information once a form has been filled out and submitted. It is the programmer that must bind the UI with the BL. This solution is not object oriented. It creates forms that have the options ‘OK’ and ‘Cancel’; however, a user cannot choose a method to invoke on an object.

Another currently known solution provides the automatic generation of a presentation layer (PL). This solution requires the schema to be provided in XML. However, the XML must be populated by a human. It does not know what to do with the information in a form once the form has been filled out and submitted; the programmer must bind the UI with the BL. This solution is not object-oriented. This solution allows a user to fill out a form and press ‘OK’ or ‘Cancel’, but it does not allow users to choose which method to invoke within an object. His use of the word schema relates to an Xml message, and not the layout of software objects. The invention is the functional equivalent of a browser that renders forms using Xml and Xsd instead of HTML.

Another currently known solution provides a method, system, and computer program product for generating a front end graphical user interface (GUI) for a plurality of text based commands. By design, this solution creates a single form that passes acquired data to a single console based application. This solution completely depends on a human developer to write schema information about the console application. Also, it is not object oriented, but the equivalent of a single method.

In summation, none of the prior arts support multiple RTE(s) or inter-RTE communication, none support form creation from the schema acquired automatically from the BL, none allow object-oriented interaction by a user, none support generating either standalone or distributed versions of the BL, and none provide automatic and repeated transfer of data back and forth between a generated form and the BL, and all require a human developer to write code binding the UI to the PL.

In view of the foregoing, there is a need for improved techniques to automatically generate PLs for software applications that can be run on any RTE as standalone or distributed applications and require no developer assistance in connecting the PL to the BL.

### BRIEF DESCRIPTION OF THE DRAWINGS

The present invention is illustrated by way of example, and not by way of limitation, in the figures of the accompanying drawings and in which like reference numerals refer to similar elements and in which:

Table 1 illustrates exemplary code for a simple yet complete App1 application written in C++ that implements and instantiates both a CCalculator object and a CReverse object and will be interacted with via the automatically created PL, in accordance with an embodiment of the present invention;

Table 2 illustrates exemplary code for the base classes which could be provided by the invention for software developers to use in the creation of BL in order to enhance usability and functionality of their applications;

Table 3 illustrates exemplary code of the Calculator class, written in a different language, using the invention supplied base classes from Tablet to demonstrate a higher level of relationship recognition;

FIG. 1 illustrates an exemplary ‘App1’ object from the CApp application illustrated by way of example in Table 1, in accordance with an embodiment of the present invention;

FIG. 2 illustrates an exemplary ‘CCalculator’ object from the App1 application illustrated by way of example in Table 1, in accordance with an embodiment of the present invention;

FIG. 3 illustrates an exemplary ‘CReverse’ object from the App1 application illustrated by way of example in Table 1, in accordance with an embodiment of the present invention;

FIG. 4 illustrates an exemplary ‘CCalculator’ object from the App1 application where the PL targets, and is displayed by, a browser RTE, illustrated by way of example in Table 1, in accordance with an embodiment of the present invention;

FIG. 5 is a flowchart illustrating an exemplary process of creating an executable at design-time from BL created by a software developer, in accordance with an embodiment of the present invention;

FIG. 6 is a flowchart illustrating an exemplary process within an automatic UI generation solution to generate form UI code, in accordance with an embodiment of the present invention;

FIG. 7 is a flowchart illustrating an exemplary process for populating a form, in accordance with an embodiment of the present invention;

FIG. 8 is a flowchart illustrating an exemplary process for generating UI controls for properties, also known as member variables, of an application, in accordance with an embodiment of the present invention;

FIG. 9 is a flowchart illustrating an exemplary process for generating UI controls for methods of an application, in accordance with an embodiment of the present invention;

FIG. 10 is a flowchart illustrating an exemplary process where the invention is embedded within a Visual Development Environment;

FIG. 11 is a block diagram illustrating the architecture of a standalone app whose UI is generated at runtime, in accordance with an embodiment of the present invention;

FIG. 12 is a block diagram illustrating an exemplary application where the platform is the RTE of a single PC and a standalone app is built at design time, in accordance with an embodiment of the present invention;

FIG. 13 is a block diagram illustrating an exemplary application where the user will interact with the BL across a network, and hence, generated as a client/server application, in accordance with an embodiment of the present invention;

FIG. 14 is a block diagram illustrating an exemplary application built as a standalone application targeting a variety of RTE(s) using various languages, in accordance with an embodiment of the present invention;

FIG. 15 is a block diagram illustrating an exemplary application built at design time as a distributed application with a UI generated for multiple RTE(s), in accordance with an embodiment of the present invention;

FIG. 16 illustrates an exemplary App2 object from the App2 class illustrated by way of example in Table 3, in accordance with an embodiment of the present invention;

FIG. 17 illustrates an exemplary ‘mCalculator’ object of type Calc2 from the App2 application illustrated by way of example in Table 3, in accordance with an embodiment of the present invention;

FIG. 18 illustrates how tabular data may be presented by using a grid control, in accordance with an embodiment of the present invention;

FIG. 19 illustrates how the same data from FIG. 18 may be presented as a graph by using a chart control, in accordance with an embodiment of the present invention; and

FIG. 20 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other aspects and in accordance with the purpose of the invention, a method and a computer program product for automatically generating a user interface for an application program is presented.

In one embodiment a method includes steps for receiving, into a computing machine, a business logic (BL) source code for an application program, steps for transforming, in the computing machine, the BL source code into an executable BL, steps for acquiring schema information, steps for generating, in the computing machine, a user interface (UI) source code, and steps for transforming, in the computing machine, the UI source code into at least one executable UI. Another embodiment further includes steps for linking, in the computing machine, the executable BL and the executable UI into a standalone application.

In another embodiment a method includes the steps of receiving, into a computing machine, a business logic (BL) source code for an application program, the BL source code comprising at least a class, an object and a method or function. Steps transform, in the computing machine, the BL source code into an executable BL. Steps acquire schema information from the BL source code. Steps generate, in the computing machine, a user interface (UI) source code for a form using the schema information for the class. Steps transform, in the computing machine, the UI source code into at least one executable UI. In another embodiment the at least one executable UI is configured for execution in at least one run-time environment. In yet another embodiment the at least one executable UI enables coupling of data exchange with the executable BL. In still another embodiment the form is populated with properties and the method or function. In another embodiment the at least one executable UI enables execution of the method or function. In yet another embodiment the at least one executable UI enables displaying, on the form, results of the executed method or function. In still another embodiment the at least one executable UI enables interaction of the application by a user in an object oriented (OO) manner. Another embodiment further includes the step of linking, in the computing machine, the executable BL and the executable UI into a standalone application. In yet another embodiment the executable BL is configured for execution on a server computing machine and the executable UI is configured for execution on a client computing machine.

In another embodiment a computer program product residing on or being distributed across one or more computer readable mediums having a plurality of instructions stored thereon which, when executed by one or more associated processors, cause the one or more processors to receive a business logic (BL) source code for an application program, the BL source code comprising at least a class, an object and a method or function. One or more processors transform the BL source code into an executable BL. One or more processors acquire schema information from the BL source code. One or more processors generate a user interface (UI) source code for a form using the schema information for the class. One or more processors transform the UI source code into at least one executable UI. In another embodiment the at least one executable UI is configured for execution in at least one run-time environment. In yet another embodiment the at least one executable UI enables coupling of data exchange with the executable BL. In still another embodiment the form is populated with properties and the method or function. In another embodiment the at least one executable UI enables execution of the method or function. In yet another embodiment the at least one executable UI enables displaying, on the form, results of the executed method or function. In still another embodiment the at least one executable UI enables interaction of the application by a user in an object oriented (OO) manner. Another embodiment further includes instructions when executed by one or more associated processors, cause the one or more processors to link the executable BL and the executable UI into a standalone application. In yet another embodiment the executable BL is configured for execution on a server computing machine and the executable UI is configured for execution on a client computing machine.

Other features, advantages, and aspects of the present invention will become more apparent and be more readily understood from the following detailed description, which should be read in conjunction with the accompanying drawings.

### DETAILED DESCRIPTION OF PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of at least some preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

At least some preferred embodiments of the present invention provide a software programming paradigm combined with a software component that enables applications written in any language to be run on any supported platform/RTE as a standalone application, or as a distributed (client/server) application(being either inside or outside of a browser), with no code changes.

At least some preferred embodiments are able to achieve RTEI by requiring the software developer to write only the BL of the application, and not the UI.

In order to use the BL from a targeted RTE, at least some preferred embodiments automatically generate the UI for that RTE (either at design-time or at runtime) and integrate the UI with the BL. This unbinds the BL from any platform-specific or RTE specific UI code, thereby allowing the application to be executed on any RTE. Examples will begin with the UI being generated at design-time since it is traditional; however, the process for generating the UI at runtime is virtually identical in concept.

The fundamental difference between generating the UI at design time versus runtime is that when an application is built with the UI generated at design time, the generated UI source code is persisted (saved to disk) alongside the BL source code, then compiled and linked with the BL code and hence need not be regenerated with each invocation of the application. For distributed applications the UI code is not linked to the BL code, but is instead instructed on how to communicate with it, but is compiled into an executable just once as well. When generating the UI at runtime, the resultant UI is created only in the memory of the machine and is not persisted, and will be re-generated every time the application is launched. The usual reason of choosing to generate the UI at runtime is that during runtime, more information can be gathered regarding the target architecture, allowing foundation-specific optimizations, such as those related to processor make and model. Another reason an application may be released with a runtime generated UI is to provide UIs for BL which could be created in the future, at runtime, such as in the case of self-modifying code, or user-written BL. Finally, runtime UI generation may be chosen to allow program updates of the UI generator to be separate from program updates of the BL. The implication of generating UIs at runtime is that the invention must be accessible in order to be invoked; this means the invention must exist on the machine of the user.

The requirement that developers write only the BL of an application should be viewed as more of a relief than a requirement; however, this strict separation between BL and UI code may be referred to as UI abstraction and will most likely be greatly appreciated by code design purists. Separation of the BL and the UI is only half of the battle as somehow the two must be joined. This is what at least some preferred embodiments do after the UI is created. The generated UI becomes a direct 1 to 1 mapping of, and linkage to, the BL.

One feature that distinguishes at least some preferred embodiments of the present invention from the prior art is that the creation of the UI and the binding of its functionality to the BL is to be performed completely by invention software. Furthermore, the binding between the UI and the BL in at least some preferred embodiments is flexible enough to create either standalone applications or network applications. The manner in which this is achieved varies greatly depending upon the RTE and language; however, those skilled in the art, in light of the present teachings, will readily recognize that for any RTE and/or language there exist means to achieve those ends. At least some preferred embodiments also acquire the schema info automatically, similar to a debugger, yet enable developers and users to override and customize forms by using invention supplied classes, or inserting custom meta codes into the schema, or making requests to the generated UI. Another distinguishing feature of at least some preferred embodiments is that the UI forms persist as they execute methods. In other words, while currently known GUI generators close after they gather data, at least some preferred embodiments of the present invention can execute a method and then display the calculated result on the same form. The form remains to interact with the user until the user chooses to close it. In at least some preferred embodiments, the forms are not data requests, but the application itself.

Since an application may be run in a browser or other distribution source such as, but not limited to, networked computers, computers built into cars or cell phones, tasks such as, but not limited to, data validation can be performed by the client rather than by the BL which is residing on the server, in order to reduce network traffic.

Another distinguishing feature in at least some preferred embodiments of the present invention is that the solution works as an object-oriented exploratory tool, so that at runtime the program's objects and their methods and properties are presented to a user to be invoked and interacted with. Prior art creates data request forms, which are single forms with data fields meant to be filled out by a user. Upon completions of filling out these forms, the user can only press the equivalent of ‘OK’ or ‘Cancel’ buttons, and after that the developer must write code determining the usage of said data.

Table 1 illustrates exemplary code for a simple yet complete application which provides a user access to an object which reverses a string, and a calculator object, written in C++ which will rely on an automatic UI generation solution, in accordance with an embodiment of the present invention. In the present embodiment, the application defines a class ‘CCalculator’ that performs simple calculations, a class ‘CReverse’ that reverses strings, and a class ‘App1’ that instantiates and contains a ‘CCalculator’ object and a ‘CReverse’ object. This application is pure BL.

In the present embodiment, the developer writes only the BL, and the automatic UI generation solution creates the UI code. Once the philosophy and general practices have been conveyed, the present embodiment does not need many details for someone skilled in the art to implement. Those skilled in the art, in light of the present teachings, will readily recognize that the specifics of every OS, language, browser, and network technology are wildly divergent. Therefore, the details given here are intentionally abstract, given that the goal of each step is achievable for each platform, OS, RTE or language, although in varying manners. As with a debugger, the automatic UI generation solution must be provided with details (i.e., schema) of the objects to display, these include, but are not limited to, properties (member variables), methods, and parameters of those methods. Therefore, for any language to be supported there must be a version of the UI generation solution that can either parse that language and extract schema information, or share the schema information provided by the DTE compiler. Once the schema information is known, there must be a version of the UI generation solution that can output UI code for the targeted RTE. The language that the UI is created in does not need to be the same language as the BL.

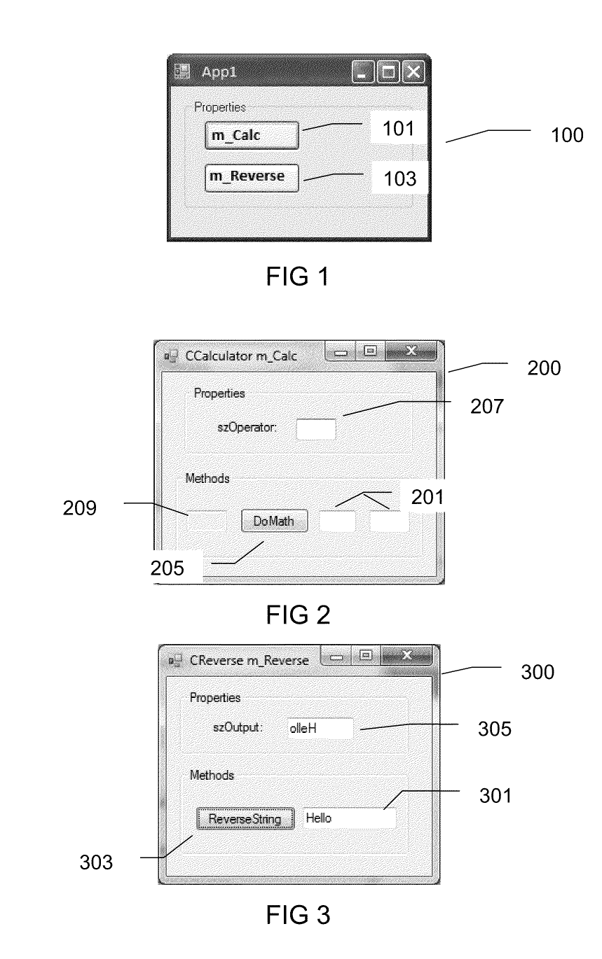

For FIGS. 1-4, Microsoft's naming convention is used to help distinguish classes and variables. C++ classes are prepended with a ‘C’, and member variable are prepended with an ‘m_’. So class ‘App’ becomes ‘CApp’.

FIG. 1 illustrates an exemplary ‘App1’ object 100 created from the ‘CApp’ class illustrated by way of example in Table 1, in accordance with an embodiment of the present invention. FIG. 1 shows how the automatic UI generation solution may cause ‘App1’ object 100 to appear as a native application on an OS. In the present embodiment, ‘App1’ object 100 comprises a m_Calc button 101 which represents the ‘m_Calc’ object (of class CCalculator), and a ‘m_Reverse’ button 103, which represents the m_Reverse object (of class CReverse). The App1 object displays its member variables, and allows the user to display either a ‘CCalculator’ object, shown by way of example in FIG. 2, or a ‘CReverse’ object, shown by way of example in FIG. 3.

FIG. 2 illustrates an exemplary ‘CCalculator’ object 200 from the calculator application illustrated by way of example in Table 1, in accordance with an embodiment of the present invention. FIG. 2 shows how the automatic UI generation solution may render the m_Calc object of class CCalculator 200 on an OS. In the present embodiment, CCalculator object 200 is expressed in UI controls and comprises method fields 201 into which a user enters numbers, a szOperator field 207 that enables the user to specify an operator, a DoMath button 205, and a read-only field 209 to display the return value of the DoMath method. Once the user clicks DoMath button 205, the DoMath method of the CCalculator object is invoked with the values of the fields passed as paramaters, and the answer appears in a value field 209.

FIG. 3 illustrates an exemplary m_Reverse object of class CReverse 300 from the ‘App1’ application illustrated by way of example in Table 1, in accordance with an embodiment of the present invention. FIG. 3 shows how the automatic UI generation solution may render CReverse object 300 on an OS. In the present embodiment, m_Reverse object 300 comprises a method parameter field 301, a ReverseString button 303 and an szOutput field 305. To use the ‘Reverse’ method, the user would enter a string of characters into the method's parameter 301, then press the ReverseString button 303. The data in the method's parameter 301 is passed to the BL, which reverses the string and passes the data back to the UI, which displays the reversed string in the object's property 305.

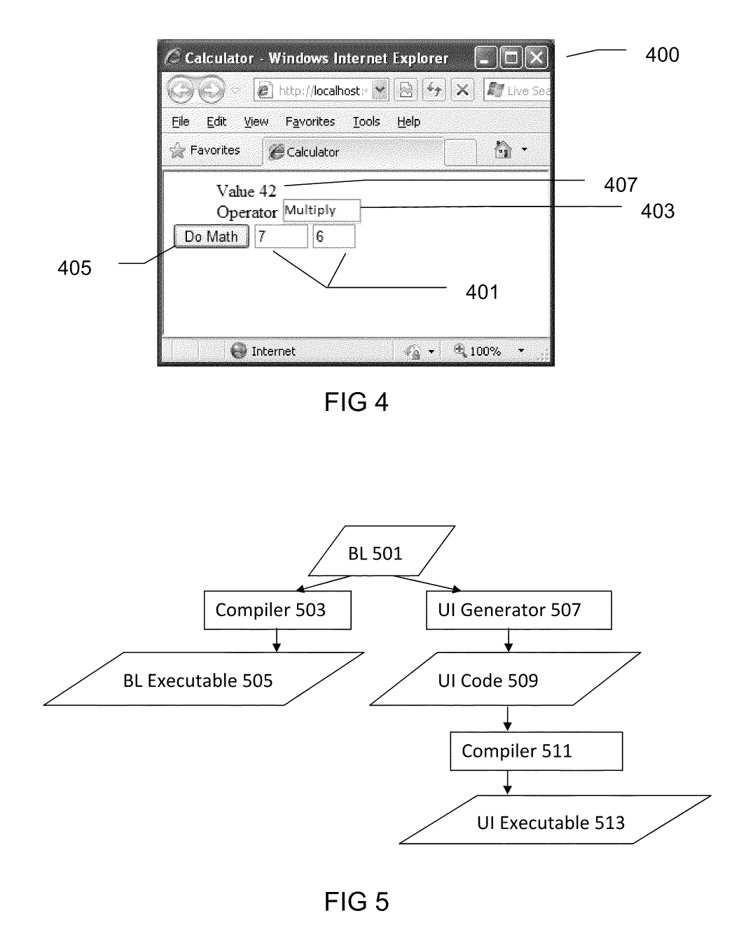

FIG. 4 illustrates an exemplary ‘CCalculator’ object 400 from the ‘App1’ application illustrated by way of example in Table 1, in accordance with an embodiment of the present invention. FIG. 4 shows how the automatic UI generation solution may render ‘CCalculator’ object 400 on a browser, rather than on an OS. Although the UI appears different due to being displayed in a different RTE, the same BL code is executed, and the behavior is identical to the ‘CCalculator’ object from the preceding example. Since this is a distributed app, the UI could have extra code which validated that the text in the method's parameters were valid numeric values. This would prevent unnecessary network traffic. But the process of adding of validation checks will not be explained here, only pointed out where it could be useful.

It is pointed out here that the user is dealing with objects interactively, using an Object Oriented Interaction (OOI), such as invoking methods, passing parameter with those methods, and viewing changes to object member variables and properties. To further illuminate, in FIG. 1 the user was presented the objects of the ‘App1’ object. By clicking the buttons that represented the ‘App1’ objects, the user was subsequently presented with a view that displayed either the ‘CCalcuator’ or the ‘CReverse’ objects. The ‘DoMath’ and ‘Reverse’ methods were invoked as method objects of their respective parent objects. It can be best explained now that the object oriented app is interacted with by using an object oriented UI.

FIGS. 5-9 illustrate exemplary processes for generating the objects shown by way of example in FIGS. 1-4 from the code shown by way of example in Table 1. FIG. 5 is a flowchart illustrating an exemplary process of creating an executable from BL created by a software developer, in accordance with an embodiment of the present invention. In the present embodiment, the process begins at step 501 where the software developer creates the BL. In step 503, the BL is passed to a compiler, which generates executable code as output in step 505. Upon successful compilation, the BL or its schema is passed to an automatic UI generation solution in step 507 which then generates UI code in step 509 which is passed to the compiler in step 511. In step 513, the resultant executable code acts as the UI for the previously generated BL code. The output executables from steps 505 and 513 can then be run as a standalone application by being merged into a single program or can be distributed among different machines by communicating through a network.

The present embodiment accepts the BL source code for an application and creates a UI that functions largely as a debugger enhanced to support OO method invocations. That is to say every method can be invoked, and the contents of every variable may be viewed and interacted with by a user. More complex embodiments enable the software developer to add variable constraints, restrict access to certain methods and/or objects, rename objects, specify visual layouts and control grouping, and add decorative features.

Furthermore, in alternate embodiments, automatic UI generation solutions can easily be made to operate at runtime. There are cases where this can be advantageous, however it requires invention to be distributed to user's machines. In some embodiments, the text, positions and directions of displayed UI controls can be decided automatically by the UI generation solution or can be influenced by a human. For example, text can be displayed right to left, or left to right, depending on user preference or locale. Taken further, the word ‘LastName’ may be displayed in whatever language and character set is required, with substitution being done at runtime. Additionally, some embodiments may enable the user to customize the preferences they desire at runtime.

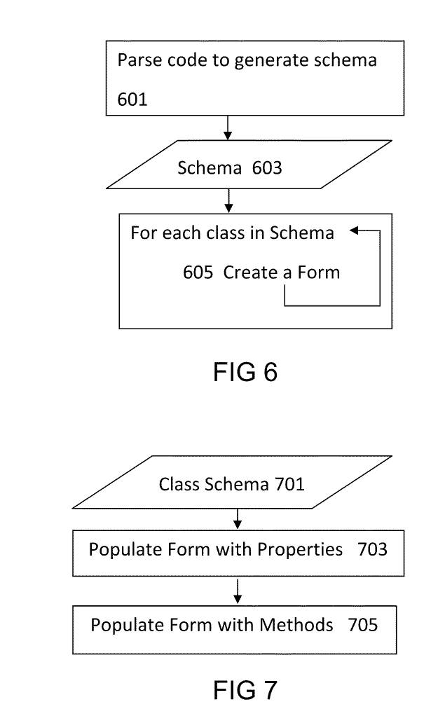

FIG. 6 is a flowchart illustrating an exemplary process within an automatic UI generation solution to generate UI code, in accordance with an embodiment of the present invention. In the present embodiment, the process begins at step 601 where the schema, if not provided, is discovered by parsing the code. In our example, the App1, CCalculator, CReverse classes would be parsed.

Different languages have different ways in which the UI generation solution may acquire the schema information about the program for example, without limitation, parsing BL code as a compiler does, using the schema information discovered by a compiler, using Reflection (supported by Java and C#), or from schema data that a programmer could either embed in the code, or provide elsewhere. Also, due to language specifics, each language has different ways the software developer can specify any overriding characteristics. In step 603, the schema is obtained. From this schema, forms are generated for each class in the schema in step 605.

FIGS. 7-9 provide more detail on how, by referencing the schema, controls are laid out upon a form allowing the interaction of the application by the user in an OO manner. FIG. 7 is a flowchart illustrating an exemplary process for populating a form, in accordance with an embodiment of the present invention. Once the class schema is referenced in step 701, the forms are populated with properties in step 703. Examples of properties that may populate a form may include, without limitation, an object's name, an object's id, the current selection of a list of choices, the resultant value of some operation, contained objects, etc. Then, in step 705, the forms are populated with methods. These methods may include, without limitation, methods to create new objects, methods to destroy objects, methods to perform calculations, methods to communicate events to other objects, methods to open documents. , etc. Information about methods includes, but is not limited to, Name, Return type, Parameter metadata, Display Name, Hide, etc. In some embodiments, the developer can choose to hide methods from users, or may choose to conditionally hide or show properties and/or methods based on a user's security level or other criteria.

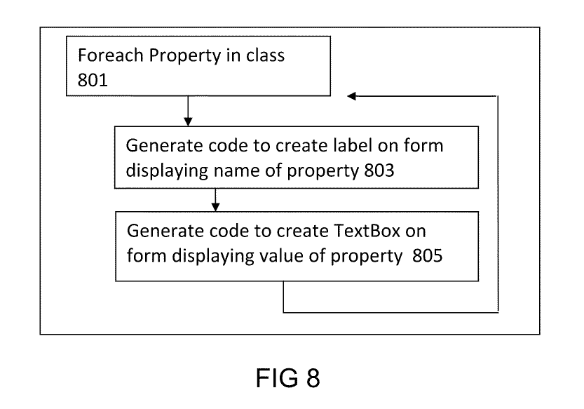

FIG. 8 is a flowchart illustrating an exemplary process for generating UIs for properties of an application, in accordance with an embodiment of the present invention. This process is performed for each property in a class. The process begins at step 801 by obtaining a property of a class. In step 803 code is generated to create a label on a form to display the name of the property. Then, in step 805, code is generated to create a text box on the form to display the value of the property. At present, there are two main branches in the way in which forms are generated regarding a typical OS application and a browser application. Forms targeting the OS (or RTE(s) hosted by the OS) are built using software objects very programmatically, meaning the programmer has low-level involvement with the creation and interaction of said controls. Creating forms on a browser could be done by describing the intended form in a language such as HTML, and allowing the browser to render the form itself. In reality there are many RTE choices available for the browser: Pure HTML, JSP, ASP, Java servlets, the list goes on. The details of implementation will be left to the implementer and the desired language within the chosen RTE.

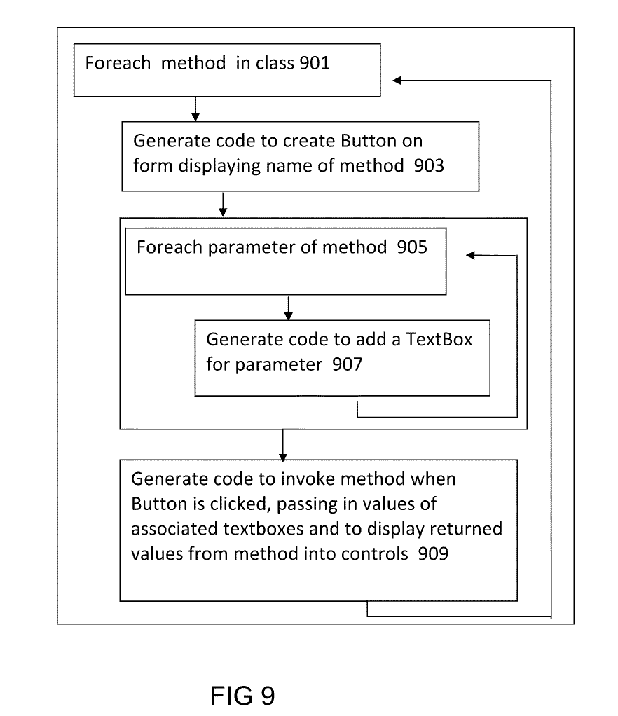

FIG. 9 is a flowchart illustrating an exemplary process for generating UIs for methods of an application, in accordance with an embodiment of the present invention. This process is performed for each method in a class. The process begins at step 901 by obtaining a method of a class. In step 903, code is generated to create a button on a form to display the name of the method. The parameters of the method are obtained in step 905. For each parameter of the method, code is generated in step 907 to add a text box for the parameter. Then, in step 909, code is generated to invoke the method when the button is clicked, passing in associated parameters. For example, in the case of C#, the Click event handler of the button has the method added to the delegates list of methods, passing in the associated parameters. The code generated would look similar to:

button2. Click+=new System.EventHandler(this.Reverse);Although examples are provided using textboxes as input/output controls for method parameters, other controls may be used instead in order to enhance appearance and functionality. For example, when a parameter is of type Boolean, a checkbox would be a more suitable control.

For other languages, the method would be invoked by the standard handlers for buttons. Information about parameters includes, but is not limited to, Name, DataType, in, out, or ref properties, and optionally Display Name, Hide, Default Value, Read Write permissions, etc.

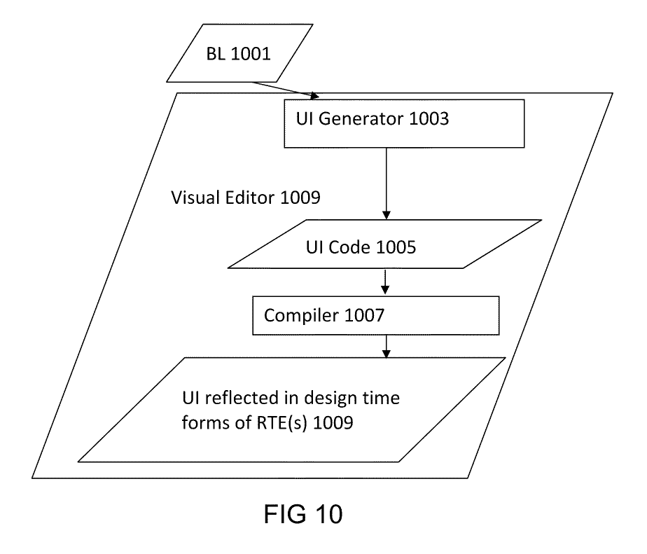

FIG. 10 is a flowchart illustrating an exemplary process within an automatic UI generation solution to generate UI code, in accordance with an embodiment of the present invention. While FIG. 5 details the use of an automatic UI generation solution where it is retrofit upon pre-existing DTE(s), FIG. 10 details the scenario where an automatic UI generation solution is integrated with the DTE. This is consistent with more modern ‘visual’ programming, where a form is populated by a user dragging an icon representing a button from a toolbox and dropping it on a form and having the form immediately be populated with a button. The UI code to add a button to the form is written automatically by the DTE. The button exists on the form, but is oblivious to the BL and does nothing when clicked. A DTE supporting the automatic UI generation solution, as provided in the present embodiment, operates similarly, but also wires the button to the method. When a user adds an object to a class or a parameter to a method, the form automatically reflects the presence of the new object visually. This button, which was automatically created by the UI generation solution, invokes the associated method when clicked. Put simply, creating a method causes a button to be created and programmed to invoke that method when clicked, and is added to the design time form.

In the present embodiment, the process begins at step 1001 where a software developer creates a new method the BL. Then, in step 1003, the BL is passed to the automatic UI generation solution, which then generates UI code to add a button to the form and call said method when button is clicked in step 1005. This UI code is passed to a compiler in step 1007. Once compiled, the UI code is passed to a visual editor in step 1009 where a visual rendering of the UI code is created. Likewise, when a parameter is added to a method, an input/output control such as a textbox is added to the form as a method parameter. The data in the control is passed to the method when it is invoked by the button. Properties are automatically reflected on the UI as well.

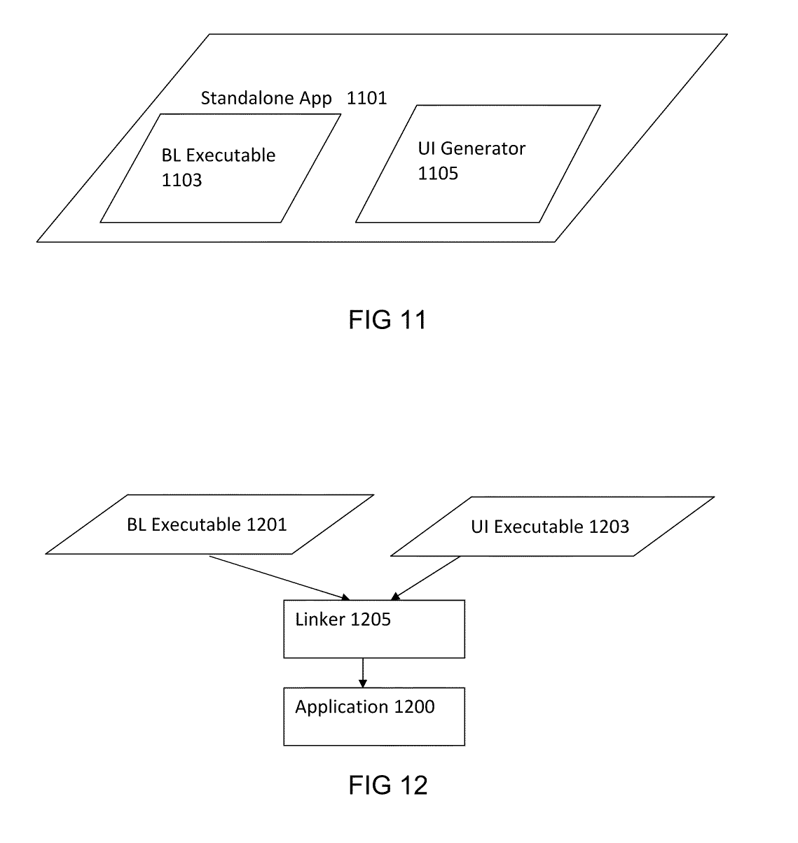

FIG. 11 is a block diagram illustrating a standalone application with a runtime generated UI. The application 1101 contains the BL executable code 1103 along with the UI Generator 1105 which renders the viewable objects in real-time as the user interacts with the application.

FIG. 12 is a block diagram illustrating an exemplary application 1200 where the RTE is the OS of a single PC, in accordance with an embodiment of the present invention. In the present embodiment, the executables illustrated by way of example in FIG. 5, which include a BL executable 1201 and a UI executable 1203 are merged together by a linker 1205 to form single application 1200, resulting in optimal communication speeds.

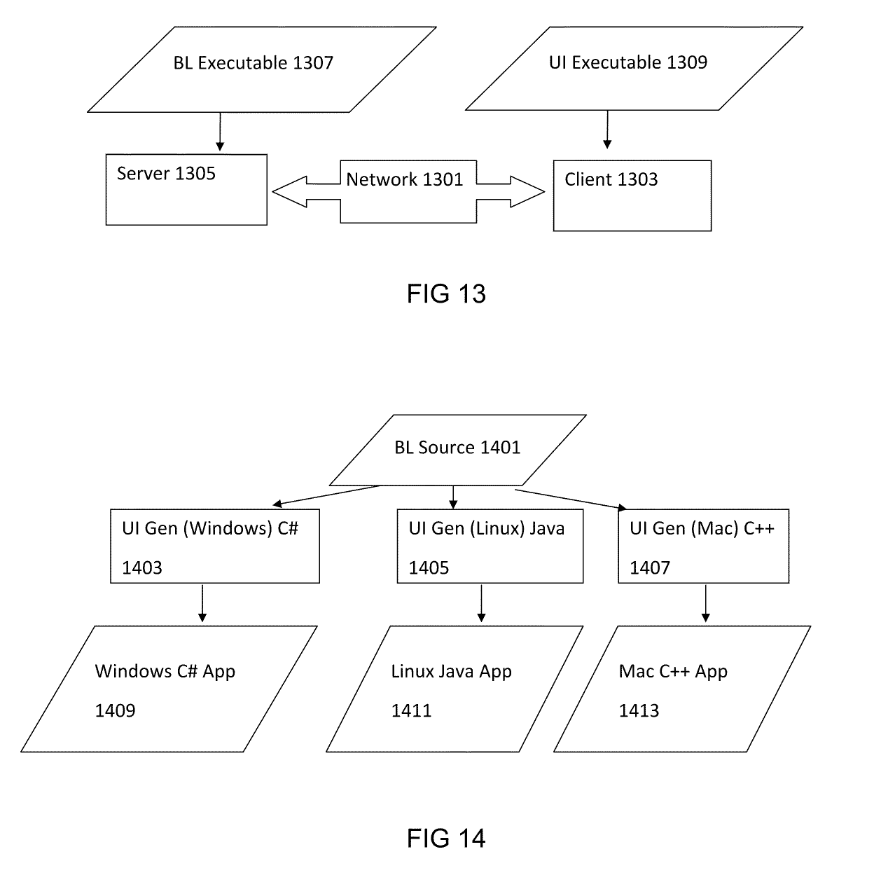

FIG. 13 is a block diagram illustrating an exemplary application where the platform is a browser for a network 1301, and hence, generated as a client/server application, in accordance with an embodiment of the present invention. In the present embodiment, network 1301 connects a client 1303 to a server 1305. A BL executable 1307 resides on server 1305 and a UI executable 1309 resides on client 1303.

FIG. 14 is a block diagram illustrating an exemplary application built as a standalone application targeting a variety of RTE(s)/OS(s) in various languages, in accordance with an embodiment of the present invention. In the present embodiment a BL source 1401 is passed to multiple automatic UI generation solutions for the different OSs, a Windows UI generation solution 1403, a Linux UI generation solution 1405 and a Mac UI generation solution 1407 in the present example. Each of these UI generation solutions then create an application to be run on each RTE, a Windows application 1409, a Linux application 1411 and a Mac application 1413. Those skilled in the art, in light of the present teachings, will readily recognize that automatic UI generation solutions may be used to create applications for a variety of different RTE(s) such as, but not limited to Windows, C#, Java, Flash, Unix/Linux with X-Windows variations, Mac, embedded OS on cell phones and car computers, etc.

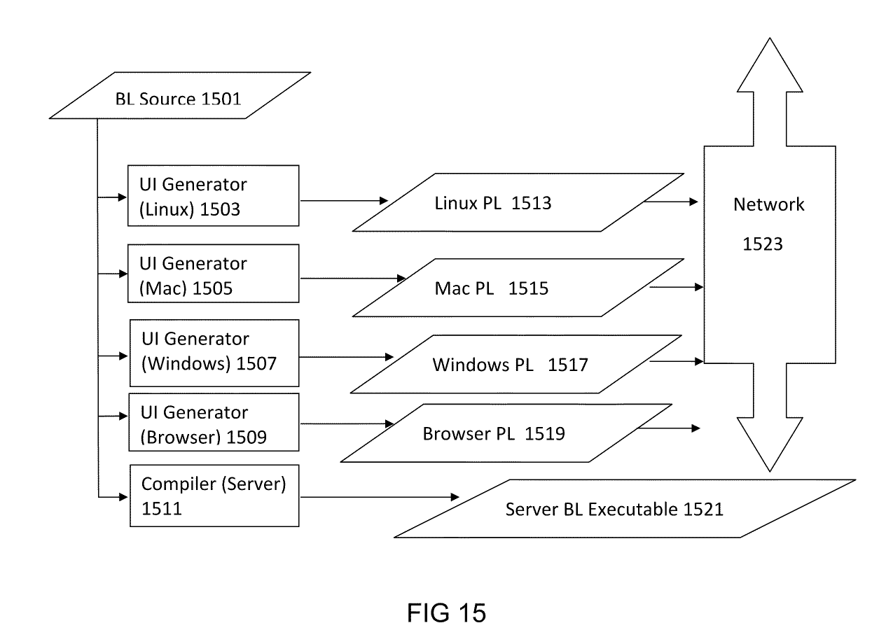

FIG. 15 is a block diagram illustrating an exemplary application built as a distributed application with a UI generated for multiple RTE(s) as well as for a browser, in accordance with an embodiment of the present invention. In the present embodiment, as in the previous embodiment, there must be an automatic UI generation solution version for each intended target RTE. The present embodiment comprises a Linux UI generation solution 1503, a Mac UI generation solution 1505, a Windows UI generation solution 1507, a Browser UI generation solution 1509, and the compilation of the BL by a compiler 1511 into an executable which will reside on the server 1521. A BL source is processed by a DTE, and the resultant schema information is then passed to each of these UI generation solutions. Linux UI generation solution 1503, Mac UI generation solution 1505, Windows UI generation solution 1507, and Browser UI generation solution 1509 create the PLs for their respective RTE(s), a Linux PL 1513, a Mac PL 1515, a Windows PL 1517 and a Browser PL 1519. The Server now hosts the BL executable 1521, which may be connected to via the network 1523 by any client.

The previous example displayed a modular design of the invention where the schema is discovered from a specific language and relayed to PL generators. This allows new languages to be supported without PL generators necessarily being made aware of any specific language other than the one in which they generate the resultant UI. However, despite this being the ideal design, the invention could still be made to work if it were monolithic, meaning, for every version of the invention all languages supported would be built into the invention. In the case of that scenario, the BL source of FIG. 15, and not the schema, would be passed to every UI Generator. Nevertheless, regardless of architectural implementation, the invention carries out the same steps and achieves the same results.

Previous examples have been very simplistic in nature, exposing the true BL just as a debugger would. In reality, only software developers would appreciate this approach. End users cannot have access to all the methods of an object, nor do they want to see objects having names that programmers use in source code. The following use hypothetical and sample base classes made to enhance the performance and usability of invention. These sample classes are presented in Table 2, and allow hiding methods, renaming objects, and the ability to specify a list and to choose an item from that list.

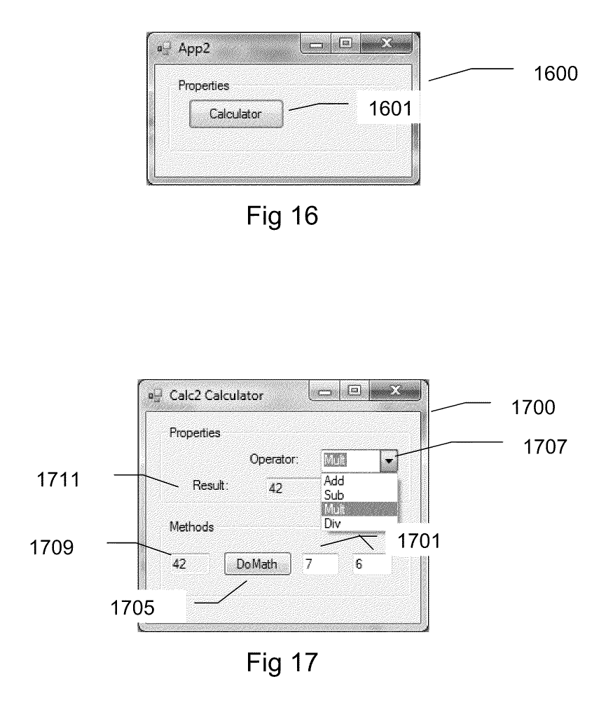

FIG. 16 is the resulting PL from re-creating the CApp as App2 1600 by using C# source code, which uses invention provided ‘Magic’ classes from Table 3. The button 1601 now has user-friendly names of “Calculator” instead of the source code object name “mCalculator”, since the ‘DisplayAs’ property of the Calc2 object mCalculator was populated and is now shown to the user. The line of code is: mCalculator.DisplayAs=“Calculator”;

FIG. 17 Shows the mCalculator 1700 of class Calc2 with human friendly object names. The Operator 1707 is now a drop-down listbox offering a choice of available operations, rather than a simple textbox where anything may be entered. The DoMath button 1705 causes the DoMath method of the Calc2 class to be executed, passing in values from input fields 1701, and displaying the return value in field 1709. The result is also displayed in the Result field 1711, and is visibly seen to be read-only, reflecting the code in Table 3 where the ‘ReadOnly’ property is set to true, which makes sense since the field is used only for output, and not for input. Just as the ‘MagicSelection’ class from Tablet and illustrated in FIG. 17 allowed the creation of an enhanced control, other classes could be provided to enhance the UI, such as classes that could support Lists, Booleans, Trees, DataTables, Graphs, etc. Flexibility could also be provided in the ability to change the format in which an object displays its data. For example, a list of stock quotes could be displayed as either a table of price ranges, or as a graph, with the user being able to choose which format to display.

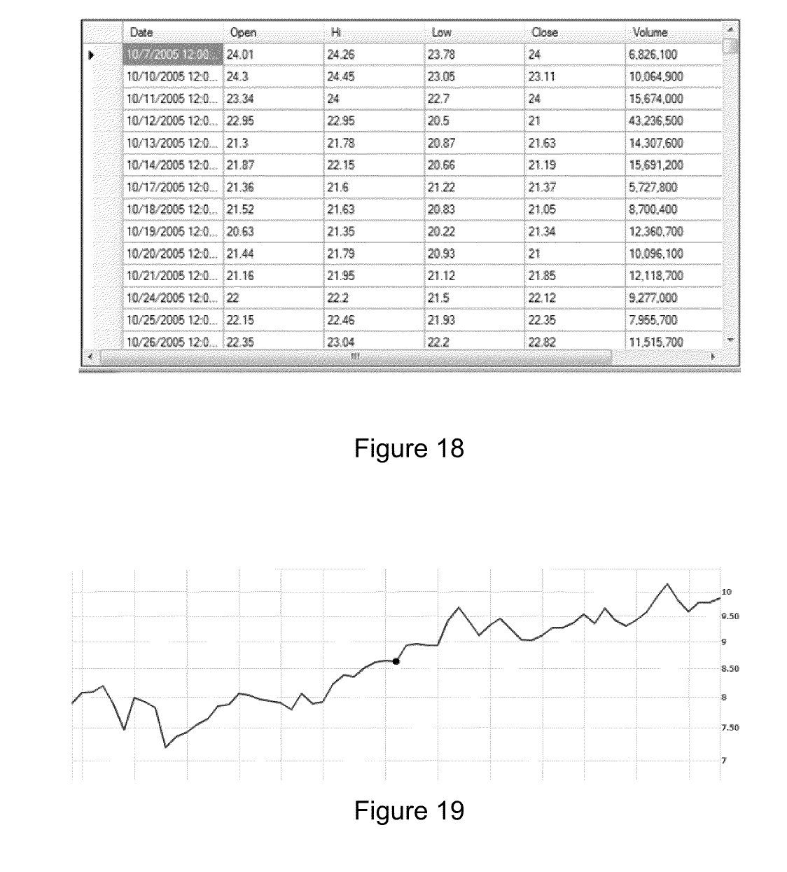

FIG. 18 shows an example of how data in a table, in this case a list of stock quotes, may be displayed using a data table. FIG. 19 shows how the same data may be viewed using a chart to graph the data.

It should be readily apparent that more complex classes can be added to the library of invention base classes that allow complete and full-featured graphical application to be developed. For example, the game tic-tac-toe could use a control that has a two dimensional array as the ‘board’. The programmer would write the BL for the game, and request that the invention display the two-dimension array in graphical format.

The claim for BL from any RTE being interacted with by any other RTE has not yet been fully met. Suppose there existed 30 year old BL written in C++, and a new RTE was invented (let's call it an xPad) that disallowed executing ‘unsafe’ native code, and could only run code written in B+, how could the archaic C++ executable be interfaced with by this newcomer? The answer is with intermediate layers. Just as when a mapping service plots a route through streets, the invention will have both the intermediate layers necessary to bridge a course from the executable code to the invoking client's RTE, and the ability to plot the optimal course.

In the case of using ancient C++ code on an xPad, let us assume that the xPad can communicate with the outside world using Web Services. Invention finds the route to take is B+ to WebServices, to C++. Therefore, the C++ BL is wrapped (encapsulated) in a layer of code that transforms the input and output of the C++ executable into Web Services, which the xPad can then use in its applications written in B+.

In the previous examples, specifically FIGS. 2 and 3, the methods that were ‘private’ to the class were not displayed to the user. However, this option can be changed allowing various levels of access. During development a developer may wish to view and interact with private properties and methods, but when released to users, the ability to show private properties and methods would be turned off.

TABLE 1

```
class CCalculator
{
private:
  float Multiply(float f1, float f2)
  {
    return f1*f2;
  }
  float Divide(float f1, float f2)
  {
    if( f2==0)
      return 0;
    else
      return f1 / f2;
  }
public:
  char *szOperator ;
  float DoMath(float f1, float f2)
  {
    if( !strcmp(szOperator, “Add”) )
      return (f1+f2 );
    else
    {
      if( !strcmp(szOperator, “Mult”) )
        return Multiply(f1,f2);
      else
      {
        if( !strcmp(szOperator, “Div”) )
          return Divide(f1,f2);
        else
        {
          if( !strcmp(szOperator, “Sub”) )
            return f1− f2;
        }
      }
    }
    return (float)0;
  }
};
class CReverse
{
public:
  char *szOutput;
  char* ReverseString(char *sIn )
  {
    int iC = strlen(sIn);
    szOutput = new char[iC];
    for(int i=0; i; i < iC; i++)
    {
      szOutput[iC−(1+i)] = sIn[i] ;
    }
    return szOutput;
  }
};
class CApp
{
public :
  CCalculator m_Calc ;
  CReverse m_Reverse ;
};|
```

TABLE 2

```
namespace Magic
{
  public class MagicBaseClass
  {
    public string DisplayName;
    public bool mbHideFromUser = false;
    public bool mbReadOnly=false;
    public string msDescription;
  }
  public class MagicFloat : MagicBaseClass
  {
    public float mfValue;
  }
  public class MagicSelection : MagicBaseClass
  {
    private HashSet<string> mChoices = new HashSet<string>( );
    public void AddChoice(string sChoice)
    {
      mChoices.Add(sChoice);
    }|
    public string Choice;
  }
}
```

TABLE 3

| ]namespace App2 | | |
|---|---|---|
| { | | |
| | using Magic; | |
| ] | class Calc2 : MagicBaseClass | |
| | { | |
| | public MagicFloat mResult = new MagicFloat( ); | |
| | public MagicSelection MathOperator; | |
| ] | public Calc2( ) | . |

| | { |
|---|---|
| DisplayName = “Calculator”; | |
| mResult = new MagicFloat( ); | |
| mResult.mbReadOnly = true; | |
| mResult.DisplayName = “Result”; | |
| mResult.msDescription = “Result of math operation”; | |
| MathOperator.DisplayName = “Operator”; | |
| MathOperator = new Magic.MagicSelection( ); | |
| MathOperator.AddChoice(“Add”); | |
| MathOperator.AddChoice(“Subtract”); | |
| MathOperator.AddChoice(“Multiply”); | |
| MathOperator.AddChoice(“Divide”); | |
| . | } |
| ] | public float DoMath(float f1, float f2) |
| | { |

```
      switch (MathOperator.Choice)
      {
        case “Add”:
          mResult.mfValue = f1 + f2;
          break;
        case “Subtract”:
          mResult.mfValue = f1 − f2;
          break;
        case “Multiply”:
          mResult.mfValue = f1 * f2;
          break;
        case “Divide”:
          mResult.mfValue = f1 / f2;
          break;
      }
      return mResult.mfValue;
    }
  }
  class App2
  {
    public Calc2 mCalculator ;
    public App2( )
    {
      mCalculator = new Calc2( );
      mCalculator.DisplayName = “Calculator”;
    }
  }
}
```

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

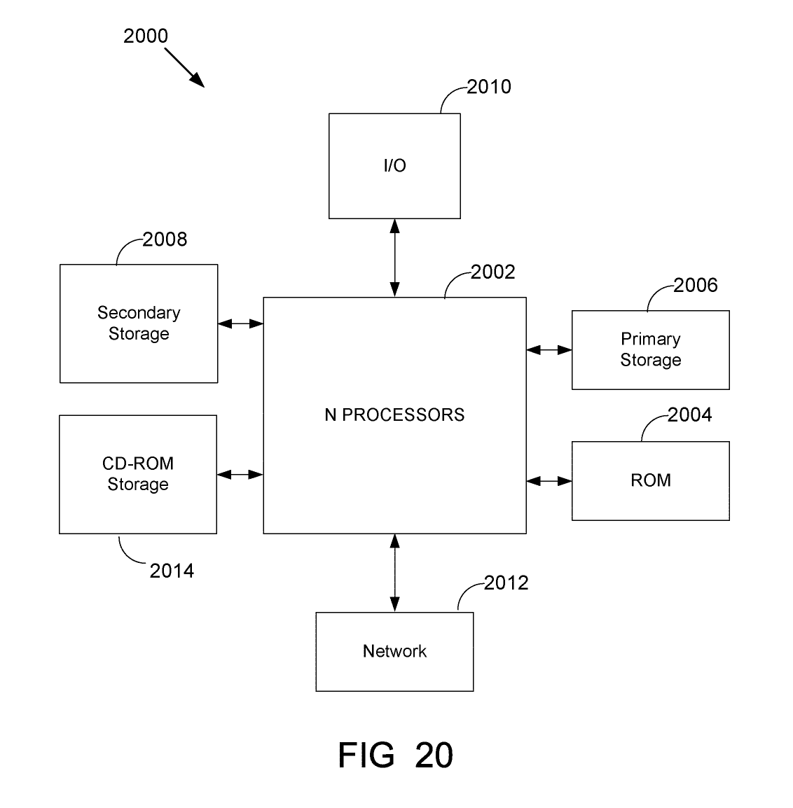

FIG. 20 illustrates a typical computer system that, when appropriately configured or designed, can serve as a computer system in which the invention may be embodied. The computer system 2000 includes any number of processors 2002 (also referred to as central processing units, or CPUs) that are coupled to storage devices including primary storage 2006 (typically a random access memory, or RAM), primary storage 2004 (typically a read only memory, or ROM). CPU 2002 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 2004 acts to transfer data and instructions uni-directionally to the CPU and primary storage 2006 is used typically to transfer data and instructions in a bi-directional manner. Both of these primary storage devices may include any suitable computer-readable media such as those described above. A mass storage device 2008 may also be coupled bi-directionally to CPU 2002 and provides additional data storage capacity and may include any of the computer-readable media described above. Mass storage device 2008 may be used to store programs, data and the like and is typically a secondary storage medium such as a hard disk. It will be appreciated that the information retained within the mass storage device 2008, may, in appropriate cases, be incorporated in standard fashion as part of primary storage 2006 as virtual memory. A specific mass storage device such as a CD-ROM 2014 may also pass data uni-directionally to the CPU.

CPU 2002 may also be coupled to an interface 2010 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 2002 optionally may be coupled to an external device such as a database or a computer or telecommunications or internet network using an external connection as shown generally at 2012, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, design and writing of BL code may be performed and/or located outside of the jurisdiction of the USA while the remaining method steps and/or system components of the forgoing embodiments are typically required to be located/performed in the US for practical considerations.

When the invention is used to render UI at runtime, the invention is distributed with the BL and located on the user's machine. Therefore, the entire set of steps are operated within the US.

Not only is the invention a software tool, but the product it produces is software, which if operated within the US would be protected by the same means that Microsoft's code is protected within the US, even the parts that were written in India and elsewhere. Is it OK to pirate Microsoft's software outside the US? Is it OK to pirate the software written outside the US? Using the invention to generate software at design time, outside the US, to be used inside the US results in pirated software.

Having fully described at least one embodiment of the present invention, other equivalent or alternative methods of providing an automatic UI generation solution according to the present invention will be apparent to those skilled in the art. The invention has been described above by way of illustration, and the specific embodiments disclosed are not intended to limit the invention to the particular forms disclosed. For example, the particular implementation of the solution may vary depending upon the particular type of program being generated. The solutions described in the foregoing were directed to UI generating implementations; however, similar techniques are to provide solutions that automatically create other types of programs such as, but not limited to, programs that run in the background of applications. Non-UI generating implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A method comprising:
steps for receiving, into a computing machine, a business logic (BL) source code for an application program;
steps for transforming, in the computing machine, said BL source code into an executable BL;
steps for acquiring schema information;
steps for generating, in the computing machine, a user interface (UI) source code; and
steps for transforming, in the computing machine, said UI source code into at least one executable UI.

2. The method as recited in claim 1, further comprising steps for linking, in the computing machine, said executable BL and said executable UI into a standalone application.

3. A method comprising the steps of:
receiving, into a computing machine, a business logic (BL) source code for an application program, said BL source code comprising at least a class, an object and a method or function;
transforming, in the computing machine, said BL source code into an executable BL;
acquiring schema information from said BL source code;
generating, in the computing machine, a user interface (UI) source code for a form using said schema information for said class; and
transforming, in the computing machine, said UI source code into at least one executable UI.

4. The method as recited in claim 3, wherein said at least one executable UI is configured for execution in at least one run-time environment.

5. The method as recited in claim 3, wherein said at least one executable UI enables coupling of data exchange with said executable BL.

6. The method as recited in claim 3, wherein said form is populated with properties and said method or function.

7. The method as recited in claim 6, wherein said at least one executable UI enables execution of said method or function.

8. The method as recited in claim 7, wherein said at least one executable UI enables displaying, on said form, results of said executed method or function.

9. The method as recited in claim 3, wherein said at least one executable UI enables interaction of said application by a user in an object oriented (OO) manner.

10. The method as recited in claim 3, further comprising the step of linking, in the computing machine, said executable BL and said executable UI into a standalone application.

11. The method as recited in claim 3, where said executable BL is configured for execution on a server computing machine and said executable UI is configured for execution on a client computing machine.

12. A computer program product residing on or being distributed across one or more computer readable mediums having a plurality of instructions stored thereon which, when executed by one or more associated processors, cause the one or more processors to:
receive a business logic (BL) source code for an application program, said BL source code comprising at least a class, an object and a method or function;
transform said BL source code into an executable BL;
acquire schema information from said BL source code;
generate a user interface (UI) source code for a form using said schema information for said class; and
transform said UI source code into at least one executable UI.

13. The computer program product as recited in claim 12, wherein said at least one executable UI is configured for execution in at least one run-time environment.

14. The computer program product as recited in claim 12, wherein said at least one executable UI enables coupling of data exchange with said executable BL.

15. The computer program product as recited in claim 12, wherein said form is populated with properties and said method or function.

16. The computer program product as recited in claim 15, wherein said at least one executable UI enables execution of said method or function.

17. The computer program product as recited in claim 16, wherein said at least one executable UI enables displaying, on said form, results of said executed method or function.

18. The computer program product as recited in claim 12, wherein said at least one executable UI enables interaction of said application by a user in an object oriented (OO) manner.

19. The computer program product as recited in claim 12, further comprising instructions when executed by one or more associated processors, cause the one or more processors to link said executable BL and said executable UI into a standalone application.

20. The computer program product as recited in claim 12, where said executable BL is configured for execution on a server computing machine and said executable UI is configured for execution on a client computing machine.
